(19) United States
(12) Patent Application Publication
(10) Pub. No.: US 2019/0156654 A1
(43) Pub. Date: May 23, 2019

(54) Unattended Occupant Alarm System

(71) Applicant: Melissa Ramos, Newark, NJ (US)

(72) Inventor: Melissa Ramos, Newark, NJ (US)

(21) Appl. No.: 15/816,584

(22) Filed: Nov. 17, 2017

(51) Int. Cl. G08B 25/00; G08B 3/10; B60Q 5/00; G01V 11/00

(52) U.S. Cl. CPC G08B 25/005; G08B 3/10; H04L 67/12; G01V 11/002; B60Q 5/005

(57) ABSTRACT

An unattended occupant alarm system includes an electronic device that may be carried by a user. A vehicle is included and the vehicle has a cabin, a trunk and an electrical system. A plurality of sensing units is provided and each of the sensing units is coupled to the vehicle. The plurality of sensing units is distributed throughout the cabin and the trunk to detect an occupant in the cabin and the trunk. Each of the sensing units is in electrical communication with the electronic device and each of the sensing units is electrically coupled to the electrical system. Each of the sensing units generates an alarm sequence after a trigger duration of time when the sensing units detects an occupant in the cabin and the trunk. The electronic device emits an audible alarm when the sensing units generate the alarm sequence. In this way the electronic device notifies the user of the unattended occupant in the vehicle. Each of the sensing units is in electrical communication with an extrinsic communication network thereby facilitating emergency responders to be contacted when the sensing units generates the alarm sequence.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to alarm devices and more particularly pertains to a new alarm device for inhibiting an individual from being locked in a trunk of a vehicle.

### BRIEF SUMMARY OF THE INVENTION

An embodiment of the disclosure meets the needs presented above by generally comprising an electronic device that may be carried by a user. A vehicle is included and the vehicle has a cabin, a trunk and an electrical system. A plurality of sensing units is provided and each of the sensing units is coupled to the vehicle. The plurality of sensing units is distributed throughout the cabin and the trunk to detect an occupant in the cabin and the trunk. Each of the sensing units is in electrical communication with the electronic device and each of the sensing units is electrically coupled to the electrical system.

Each of the sensing units generates an alarm sequence after a trigger duration of time when the sensing units detects an occupant in the cabin and the trunk. The electronic device emits an audible alarm when the sensing units generate the alarm sequence. In this way the electronic device notifies the user of the unattended occupant in the vehicle. Each of the sensing units is in electrical communication with an extrinsic communication network thereby facilitating emergency responders to be contacted when the sensing units generates the alarm sequence.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a sensing unit unattended occupant alarm system according to an embodiment of the disclosure.

FIG. 2 is a back view of a sensing unit of an embodiment of the disclosure.

FIG. 3 is a front view of a sensing unit of an embodiment of the disclosure.

FIG. 4 is a perspective in-use view of an embodiment of the disclosure.

### DETAILED DESCRIPTION OF THE INVENTION

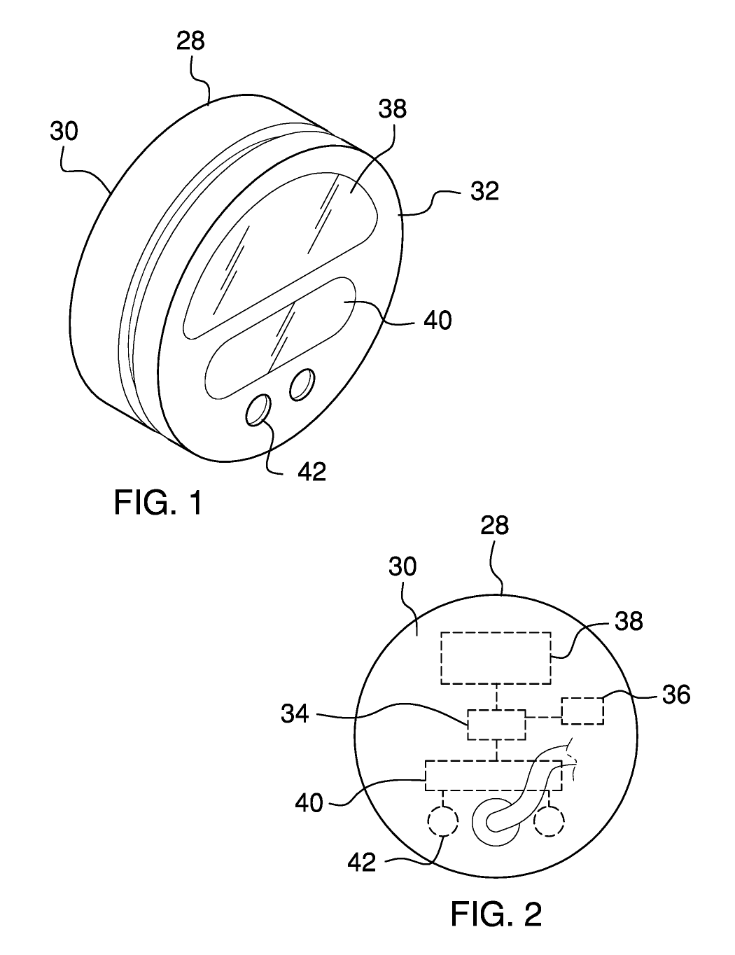

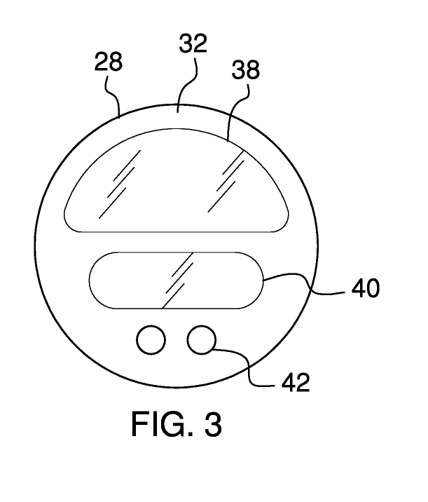

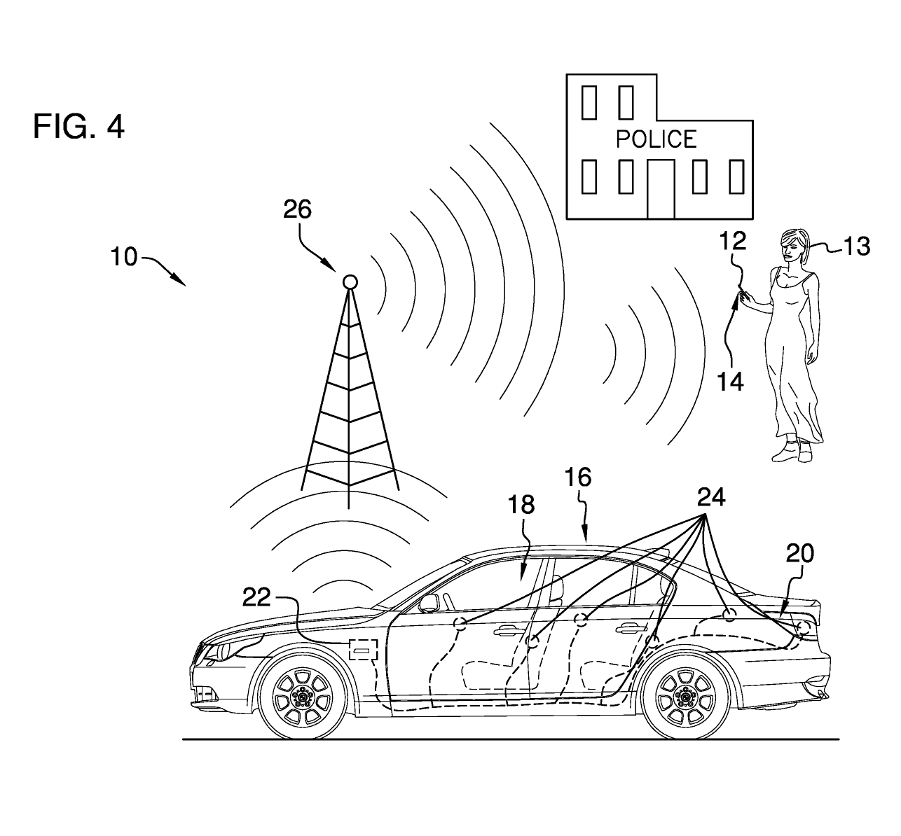

With reference now to the drawings, and in particular to FIGS. 1 through 4 thereof, a new alarm device embodying the principles and concepts of an embodiment of the disclosure and generally designated by the reference numeral 10 will be described.

As best illustrated in FIGS. 1 through 4, the unattended occupant alarm system 10 generally comprises an electronic device 12 that may be carried by a user 13. The electronic device 12 has a transceiver 14 and the electronic device 12 may be a smart phone or the like. A vehicle 16 is included that has a cabin 18, a trunk 20 and an electrical system 22. The vehicle 16 may be a passenger vehicle such as a car or the like.

A plurality of sensing units 24 is provided and each of the sensing units 24 is coupled to the vehicle 16. The plurality of sensing units 24 is distributed throughout the cabin 18 and the trunk 20 to detect an occupant in the cabin 18 and the trunk 20. Moreover, each of the sensing units 24 is electrically coupled to the electrical system 22 in the vehicle 16 as a power source. Each of the sensing units 24 generates an alarm sequence after a trigger duration of time when the sensing units 24 detects an occupant in the cabin 18 and the trunk 20. In this way the sensing units 24 inhibit the occupant from being inadvertently left unattended in the vehicle. The trigger duration of time may be approximately 10.0 minutes.

The sensing units 24 in the trunk 20 inhibit forcible entrapment in a trunk 20 and accidental entrapment in the trunk 20. Moreover, the electronic device 12 emits an audible alarm when the sensing units 24 generate alarm sequence to notify the user 13 of the unattended occupant in the vehicle 16. Each of the sensing units 24 is in electrical communication with the electronic device 12 and an extrinsic communication network 26 thereby facilitating emergency responders to be contacted when the sensing units 24 generates the alarm sequence. The extrinsic communication network 26 may be a cellular phone network, the internet and any other electronic means of communication and the emergency responders may be local law enforcement or the like.

Each of the sensing units 24 comprises a housing 28 that has a first wall 30 being spaced from the second wall 32. The first wall 30 is coupled to an inside surface of the vehicle 16 such that the second wall 32 is exposed to an interior of the vehicle 16. A processor 34 is positioned within the housing 28 and the processor 34 may be an electronic processor 34 or the like. The processor 34 is electrically coupled to the electrical system 22 in the vehicle 16 such that the processor 34 detects when the vehicle 16 is turned off. A conductor may be electrically coupled between the processor 34 and the electrical system 22. Moreover, the sensing units 24 may be a factory installed component of the vehicle 16, or alternatively, the sensing units 24 may be an aftermarket add on.

A transmitter 36 is positioned within the housing 28 and the transmitter 36 is electrically coupled to the processor 34. The transmitter 36 is in electrical communication with the transceiver 14 and the extrinsic communication network 26. The transmitter 36 transmits an alert to the transceiver 14 and the extrinsic communication network 26 when the processor 34 generates alarm sequence. The transmitter 36 may be a radio frequency transmitter 36 or the like and the transmitter 36 may employ a WPAN signal and Bluetooth communication protocols.

A motion sensor 38 is coupled to the second wall 32 of the housing 28 to detect motion in the vehicle 16. The processor 34 generates the alarm sequence when the vehicle 16 has been turned off for the trigger duration of time and the motion sensor 38 detects motion in the vehicle 16. The motion sensor 38 may be an electronic motion sensor 38 of any conventional design.

A temperature sensor 40 is coupled to the second wall 32 of the housing 28. The temperature sensor 40 is in thermal communication with an interior of the vehicle 16 to detect a temperature of the interior of the vehicle 16. The temperature sensor 40 is electrically coupled to the processor 34. Moreover, the processor 34 generates the alarm sequence when the temperature sensor 40 detects the temperature in the vehicle 16 has exceeded a trigger temperature and the motion sensor 38 detects motion in the vehicle 16. The trigger temperature may be approximately 80.0 degrees Fahrenheit. The temperature sensor 40 may be an electronic temperature sensor 40 of any conventional design.

A microphone 42 is coupled to the second wall 32 of the housing 28 to detect audible sounds. The microphone 42 is electrically coupled the processor 34 such that the transmitter 36 transmits the audible sounds to the electronic device 12 and the extrinsic communication network 26. In this way the user 13 and the emergency responders can hear if the unattended occupant is distressed. The microphone 42 may be an electronic microphone 42 of any conventional design.

In use, the transceiver 14 the electronic device 12 is synchronized with the transmitter 36 in each of the sensing units 24. The processor 34 detects when the engine is turned off after driving and the processor 34 begins counting down the trigger duration of time. The processor 34 generates the alarm sequence when the motion sensor 38 in each of these sensing units 24 detects motion after the trigger duration of time. Thus the electronic device 12 notifies the user 13 of an unattended occupant in the vehicle 16 and the transmitter 36 notifies the emergency responders. In this way the occupant is inhibited from being inadvertently left unoccupied in the vehicle 16 and from being forcibly retained in the trunk 20. The processor 34 generates the alarm sequence when the temperature sensor 40 in each of the sensing units 24 detects the temperature in the vehicle 16 has exceeded the trigger temperature. In this way the occupant is inhibited from being harmed by exposure to excessive temperatures in the vehicle 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An unattended occupant alarm system being configured to detect an unattended occupant in a vehicle, said system comprising:
an electronic device being configured to be carried by a user, said electronic device having a transceiver;
a vehicle having a cabin, a trunk and an electrical system; and
a plurality of sensing units, each of said sensing units being coupled to said vehicle, said plurality of sensing units being distributed throughout said cabin and said trunk wherein said plurality of sensing units is configured to detect an occupant in the cabin and the trunk, each of said sensing units being in electrical communication with said electronic device, each of said sensing units being electrically coupled to said electrical system, each of said sensing units generating an alarm sequence after a trigger duration of time when said sensing units detects an occupant in the cabin and the trunk, said electronic device emitting an audible alarm when said sensing units generates alarm sequence wherein said electronic devices configured to notify the user of the unattended occupant in the vehicle, each of said sensing units being configured to be in electrical communication with an extrinsic communication network thereby facilitating emergency responders to be contacted when said sensing units generates said alarm sequence.

2. The assembly according to claim 1, wherein each of said sensing units comprises a housing having a first wall being spaced from a second wall, said first wall being coupled to said vehicle such that said second wall is exposed.

3. The assembly according to claim 2, further comprising a processor being positioned within said housing, said processor being electrically coupled to said electrical system in said vehicle such that said processor detects when said vehicle is turned off.

4. The assembly according to claim 3, further comprising a transmitter being positioned within said housing, said transmitter being electrically coupled to said processor, said transmitter being in electrical communication with said transceiver, said transmitter being configured to be in electrical communication with the extrinsic communication network, said transmitter transmitting an alert to said transceiver and the extrinsic communication network when said processor generates alarm sequence.

5. The assembly according to claim 3, further comprising a motion sensor being coupled to said second wall of said housing wherein said motion sensor is configured to detect motion in said vehicle, said processor generating said alarm sequence when said vehicle has been turned off for a trigger duration of time and said motion sensor detects motion in said vehicle.

6. The assembly according to claim 5, further comprising a temperature sensor being coupled to said second wall of said housing wherein said temperature sensor is configured to be in thermal communication with an interior of said vehicle to detect a temperature of the interior of said vehicle, said temperature sensor being electrically coupled to said processor, said processor generating said alarm sequence when said temperature sensor detects a temperature exceeding a trigger temperature and said motion sensor detects motion in said vehicle.

7. The assembly according to claim 3, further comprising a microphone being coupled to said second wall of said housing wherein said microphone is configured to detect audible sounds, said microphone being electrically coupled said processor wherein said transmitter is configured to transmit the audible sounds to said electronic device and the extrinsic communication network.

8. An unattended occupant alarm system being configured to detect an unattended occupant in a vehicle, said system comprising:
an electronic device being configured to be carried by a user, said electronic device having a transceiver;
a vehicle having a cabin, a trunk and an electrical system;
a plurality of sensing units, each of said sensing units being coupled to said vehicle, said plurality of sensing units being distributed throughout said cabin and said trunk wherein said plurality of sensing units is configured to detect an occupant in the cabin and the trunk, each of said sensing units being in electrical communication with said electronic device, each of said sensing units being electrically coupled to said electrical system, each of said sensing units generating an alarm sequence after a trigger duration of time when said sensing units detects an occupant in the cabin and the trunk, said electronic device emitting an audible alarm when said sensing units generates alarm sequence wherein said electronic devices configured to notify the user of the unattended occupant in the vehicle, each of said sensing units being configured to be in electrical communication with an extrinsic communication network thereby facilitating emergency responders to be contacted when said sensing units generates said alarm sequence, each of said sensing units comprising:
a housing having a first wall being spaced from the second wall, said first wall being configured to be coupled to the vehicle such that said second wall is exposed,
a processor being positioned within said housing, said processor being electrically coupled to said electrical system in said vehicle such that said processor detects when said vehicle is turned off,
a transmitter being positioned within said housing, said transmitter being electrically coupled to said processor, said transmitter being in electrical communication with said transceiver, said transmitter being configured to be in electrical communication with the extrinsic communication network, said transmitter transmitting an alert to said transceiver and the extrinsic communication network when said processor generates alarm sequence,
a motion sensor being coupled to said second wall of said housing wherein said motion sensor is configured to detect motion in said vehicle, said processor generating said alarm sequence when said vehicle has been turned off for a trigger duration of time and said motion sensor detects motion in said vehicle,
a temperature sensor being coupled to said second wall of said housing wherein said temperature sensor is configured to be in thermal communication with an interior of said vehicle to detect a temperature of the interior of said vehicle, said temperature sensor being electrically coupled to said processor, said processor generating said alarm sequence when said temperature sensor detects a temperature exceeding a trigger temperature and said motion sensor detects motion in said vehicle, and
a microphone being coupled to said second wall of said housing wherein said microphone is configured to detect audible sounds, said microphone being electrically coupled said processor wherein said transmitter is configured to transmit the audible sounds to said electronic device and the extrinsic communication network.
